(19) United States
(12) Patent Application Publication
(10) Pub. No.: US 2014/0186788 A1
(43) Pub. Date: Jul. 3, 2014

(54) SYSTEM AND METHOD FOR MAXILLARY PROTRACTION IN CLASS III MALOCCLUSION PATIENTS

(71) Applicants: Abdulrahman Showkatbakhsh, Tehran (IR); Ahmad Sheibani Nia, Tehran (IR)

(72) Inventors: Ahmad Sheibani Nia, Tehran (IR); Abdulrahman Showkatbakhsh, Tehran (IR)

(21) Appl. No.: 14/164,217

(22) Filed: Jan. 26, 2014

(51) Int. Cl. A61C 7/10; A61C 7/20; A61C 7/18

(52) U.S. Cl. CPC A61C 7/10; A61C 7/18; A61C 7/20
USPC 433/7

(57) ABSTRACT

The embodiments herein provide a maxillary protraction device is provided for treating Maxillary Transverse Discrepancies in young orthodontic patients and in skeletally mature patients using only local anesthesia and without administering general anesthesia. The maxillary protraction device comprises a hyrax provided with an adjustable screw and a plurality of bands connected to the hyrax through a connecting wire. A tongue plate is connected to the hyrax through the connecting wire. A tongue sprue wire is provided and soldered to an anterior segment of a premolar band to reinforce the tongue plate. The connecting wire holds the tongue plate in a position to resist a tongue pressure. The physiological tongue forces produced during swallowing are used to move the maxilla in forward, sagittal and vertical directions. The parasagittal osteotomy is employed to reposition the individual segments in a widened transverse dimension, and to facilitate 3-dimensional movements of the maxilla.

### PRIORITY APPLICATION

This application claims priority to U.S. provisional application 61/844,861 filed on Jul. 11, 2013, and entitled “Maxillary Protraction device (Combination of hyrax and tongue plate),” which is hereby incorporated by reference.

### BACKGROUND

1. Technical Field

The embodiments herein generally relate to an orthodontic system. The embodiments herein also relate to a system for treating three dimensional maxillary deficiency of Class III malocclusion. The embodiments herein more particularly relate to a maxillary protraction system and method for correcting a lateral, sagittal and vertical deficiency of CL III malocclusion.

2. Description of the Related Art

Orthopedic maxillary expansion (OME) was first described over 145 years ago by Angell in a case report when an expansion-screw was attached to the maxillary first premolars of a 14 year old girl with a constricted maxillary arch. Since then, the researchers have written about rapid maxillary expansion, and the procedure has become an accepted part of contemporary orthodontic practice.

It has been noted that rapid maxillary expansion (RME) causes not only dento-facial changes but also cranio-facial structure changes. The effects of RME are not limited to the upper jaw because the maxilla is connected with many other bones. RME separates the external walls of the nasal cavity laterally and causes lowering of the palatal vault and straightening of the nasal septum. This remodeling decreases nasal resistance, increases internasal capacity, and improves breathing.

A malocclusion is a misalignment of teeth or incorrect relation between the teeth of the two dental arches. In Class III malocclusion, the upper molars are placed not in the mesiobuccal groove but posterior to it. The mesiobuccal cusp of the maxillary first molar lies posterior to the mesiobuccal groove of the mandibular first molar. Usually the malocclusion occurs, when the lower front teeth are more prominent than the upper front teeth.

Class III malocclusion is considered to be one of the most difficult and complex orthodontic problems to treat. Individuals with class III malocclusion frequently show combinations of skeletal and dentoalveolar components. Several distinct cephalometric features, such as a short anterior cranial base length, acute cranial base angle, a short and retrusive maxilla, proclined maxillary incisors, retroclined mandibular incisors, an excessive lower anterior face height and obtuse gonial angle, are reported in class III patients. Skeletal class III malocclusion is either associated with maxillary retrusions, mandibular protrusion, or a combination of the two.

In the past, the problem of CL III was considered to be originated of the mandibular prognathism, but recently the orthodontics literature indicated that most CL III problems resulted of underdeveloped maxilla on 3-Dimension. Later investigation by proffit W R. and white P., (mosby, 2003, chapter 16, page: 507) showed that 40% of the CL III population exhibited only maxillary deficiency, 42% exhibited maxillary deficiency with mandibular prognathism and 18% both of them.

Based on the U.S. Pat. No. 7,090,489 B2, Maxillary protraction device with chin-cup needs patients' cooperation which is not needed in the system and method disclosed in the embodiments herein.

In the U.S. Pat. No. 6,908,469 B2, a compact maxillary distractor is fixed to the maxillary and zygomatic bones in order to advance the maxilla. The patient has to be under general anesthesia to have surgical cuts to separate the pterygo maxillary suture. However, in the system disclosed herein, there is no need for general anesthesia and osteotomy for loosening of pterygo maxillary suture.

The class III malocclusions account for a large proportion of orthodontic patients in the countries like Japan, China and Korea. The incidence of Maxillary Transverse discrepancies MTD in the adult population or in skeletally mature people could not be elucidated from the literature. Transverse maxilla mandibular discrepancies are a major component of several malocclusions. Orthopedic and orthodontic forces are used routinely to correct a maxillary transverse deficiency (MTD) in a young patient. Correction of MTD in a skeletally mature patient is more challenging because of determination of the osseous articulations of the maxilla with the cranial bones.

Because of more complications after attempts to orthopedically alter the transverse dimension of the maxilla with advancing age, surgical procedures have been recommended to facilitate correction of transverse discrepancies. These procedures have conventionally been grouped into two categories. In the first category, segmenting the maxilla is segmented during a LeFort osteotomy to reposition the individual segments in a widened transverse dimension. In the second category; surgically assisted rapid palatal expansion (SARPE) is used. The Surgically Assisted Rapid Palatal Expansion (SARPE) has gradually gained popularity as a treatment option to correct MTD. It allows clinicians to achieve an effective maxillary expansion in a skeletally mature patient. Application of SARPE to treat MTD decreases the unwanted/undesired effects of orthopedic or orthodontic expansion.

A variety of orthodontic devices are available for treating the class III malocclusion. The use of restraining devices to reduce the mandibular prognathism was reported in the early 1800s. All the devices are designed based on chin cup therapy. These early attempts to correct mandibular prognathism tend to fail for two reasons. First reason is that the forces generated by appliances in the 1800s are usually too small to have an influence on condylar growth mechanisms. Second reason is that the treatment is often started after the completion of facial skeletal growth thereby leaving the practitioner with the task of literally “driving” the mandible backward in the craniofacial complex. There is no clinical concept of growth guidance.

In 1940s, protraction facemask device was introduced. The application of protraction facemask therapy to the maxilla and the maxillary dentition produces significant tension in the circum maxillary sutures and the maxillary tuberosity regions. The tension produced within the sutures is thought to cause an increase in vascularity in the region with a concomitant differentiation of the cellular tissues resulting in an increase in osteoblastic activity in the region. The protraction facemask therapy does not lead to normalisation of growth but rather the patients resumed their characteristic of Class III growth pattern of deficient maxillary growth with normal to excessive mandibular growth.

Another kind of orthodontic device for treatment of class III malocclusion is a maxillary distractor. This orthodontic system made modifications in the distance between the maxilla and zygoma bones in order to advance the maxilla. One disadvantage with maxillary distractor is that the patient has to be given general anesthesia to have surgical cuts to separate the pterygomaxillary suture.

Hence there is a need to develop a simple, efficient, and improved orthodontic device for improving the growth of the maxilla in 3-dimensional after the growth is ceased in sagittal direction. Further there is a need to improve a forward movement of the maxilla and to correct an abnormal lateral relationship and to have a good vertical control of the patient to exhibit a horizontal growth pattern.

The above mentioned shortcomings, disadvantages and problems are addressed herein and which will be understood by reading and studying the following specification.

### OBJECT OF THE EMBODIMENTS

The primary object of the embodiments herein is to develop a simple and effective system and method for treating orthodontic maxillary deficiency of Class III malocclusion.

Another object of the embodiments herein is to provide a system that combines hyrax and tongue plate to facilitate a maxillary expansion.

Yet another object of the embodiments herein is to provide a system that combines orthodontics and surgical procedures to produce a dental arch space for an alignment of teeth.

Yet another object of the embodiments herein is to provide a system that combines orthodontics and surgical procedures in which a cooperation of a patient is not needed.

Yet another object of the embodiments herein is to provide a system that combines orthodontics and surgical procedures in which a need for general anesthesia and osteotomy for loosening of pterygo maxillary suture, is eliminated.

Yet another object of the embodiments herein is to provide a system that combines orthodontics and surgical procedures to improve the growth of the maxilla in 3-Dimensional after the growth is ceased in sagittal direction.

Yet another object of the embodiments herein is to provide a system that combines orthodontics and surgical procedures to achieve a normal relationship of the maxillary arch in transverse direction.

Yet another object of the embodiments herein is to provide a system that combines orthodontics and surgical procedures to correct a growth pattern of the mandible from horizontal direction to normal growth pattern.

Yet another object of the embodiments herein is to provide a system that combines orthodontics and surgical procedures which rely on the physiological tongue force during swallowing to move the maxilla interiorly and vertically.

Yet another object of the embodiments herein is to provide a system that combines orthodontics and surgical procedures without administering general anesthesia but by using only a local anesthesia.

Yet another object of the embodiments herein is to provide a system that combines orthodontics and surgical procedures to have vertical and horizontal cut separately in the two halves of the palate vertically and horizontally.

Yet another object of the embodiments herein is to provide a system that combines orthodontics and surgical procedures to improve the forward movement of the maxilla and to correct abnormal lateral relationship and to have good vertical control of the patient showed horizontal growth pattern.

Yet another object of the embodiments herein is to provide a system that combines orthodontics and surgical procedures which is planned to be used in patient after a cessation of growth and development.

These and other objects and advantages of the embodiments herein will become readily apparent from the following detailed description taken in conjunction with the accompanying drawings.

### SUMMARY

The various embodiments herein provide a system for treating Maxillary Transverse Discrepancies (MTD) in an adult population or in the skeletally mature people. The orthopedic and orthodontic forces are adapted to correct a maxillary transverse deficiency (MTD) in young orthodontic patients. A correction of MTD in the skeletally mature patients is more challenging because of the determination of the osseous articulations of the maxilla with the cranial bones.

According to one embodiment herein, a maxillary protraction device is provided for treating Maxillary Transverse Discrepancies (MTD) in young orthodontic patients and in skeletally mature patients using only local anesthesia and without administering general anesthesia. The maxillary protraction device comprises a hyrax and a pluarality of bands is connected to the hyrax through a connecting wire. The hyrax is provided with an adjustable screw. A tongue plate is connected to the hyrax through the connecting wire. A tongue sprue wire is provided and soldered to an anterior segment of a premolar band. The tongue sprue wire is provided to reinforce the tongue plate. The connecting wire is configured to hold the tongue plate in a position to resist a functional force of a tongue. The functional force of the tongue is a pressure exerted by the tongue.

According to one embodiment herein, the connecting wire is soldered to the plurality of bands.

According to one embodiment herein, the plurality of bands is connected to the hyrax with a stainless steel wire of thickness 0.40 mm by firm soldering. Further on this connecting wire, the tongue plate is mounted and soldered tightly.

According to one embodiment herein, the tongue sprue wire is soldered to an anterior segment of the connecting wire to reinforce the tongue plate.

According to one embodiment herein, the tongue plate has a split at a centre line to facilitate an action of the hyrax screw. The two halves of tongue plate provide a mean to transfer the physiological forces of the tongue during swallowing.

According to one embodiment herein, the tongue plate has an acrylic coverage to transfer a force of a tongue to the hyrax. The acrylic coverage connects two halves of the tongue plate to provide more patient convenience.

According to one embodiment herein, the hyrax along with the tongue plate is configured to correct a growth pattern of a mandible in a horizontal direction to achieve a normal growth pattern. The movement of hyrax increases mandibular plane angle, which in turn enables normal growth pattern of the mandible.

According to one embodiment herein, the hyrax along with the tongue plate is configured to move a maxilla anteriorly and vertically.

According to one embodiment herein, the hyrax provides lateral maxillary expansion and the tongue plate applies force on maxilla in forward direction.

According to one embodiment herein, the bands are soldered and cemented to an upper position of a first molar before an osteotomy process to hold the hyrax and the mounted tongue plate, to move the maxilla in a forward and vertical direction using a tongue pressure, to correct an abnormal lateral relationship of a patient to achieve a vertical control of the patient to achieve a horizontal growth pattern.

According to one embodiment herein, the hyrax screw is adjusted to produce a bilateral force which is perpendicular to a posterior arch thereby resulting in an arch expansion.

According to one embodiment herein, the system is provided for treating Maxillary Transverse Discrepancies (MTD) in young orthodontic patients and in skeletally mature patients. The system comprises a hyrax and a tongue plate to facilitate a maxillary expansion. The hyrax comprises a plurality of bands wrapped around a first premolar and a first molar tooth of a maxilla. The plurality of bands holds the hyrax and a mounted tongue plate with a plurality of connecting wires. The plurality of bands is cemented before performing a maxillary osteotomy. The hyrax further comprises an adjustable hyrax screw which produces a bilateral force perpendicular to a posterior arch resulting in an expansion of maxillary arch. The adjustable hyrax screw provides expansion by increasing the movement of maxilla in transverse direction. The hyrax screw and the plurality of the connecting wires are soldered to the plurality of bands. The tongue plate further comprises a tongue sprue wire that is soldered to a posterior segment of a connecting wire of a premolar band to reinforce the tongue plate. The tongue plate has a split in a midline/center line to facilitate an insertion of the hyrax screw. The acrylic coverage of the tongue plate transfers a physiological force of the tongue to the hyrax.

According to one embodiment herein, a physiological tongue force during swallowing, speech and the like, is responsible for a forward, sagittal and vertical movement of the maxilla. Tongue needs enough space to have normal physiological force. The tongue plates reduce space for tongue movement; hence the physiological force of tongue increases during functions such as swallowing, speech and the like. Because of functional activity of tongue due to reduction of tongue space is responsible for maxillary expansion. The sutural loosening of the maxilla releases the maxilla from Zygomatic buttress. Maxillary midline cut facilitates a 3-dimensionsal movement of the maxilla. The midline cut also facilitate separation of maxillary halves to correct a transverse constriction.

According to one embodiment herein, parasagittal osteotomy is conducted to create a surgical cut in the parasagittal region of the maxilla. The surgical cut is performed to release the maxillary complex from adjacent hard cranial base components. The surgical process makes the vertical and horizontal cuts in the separate two halves of maxillary palate. The horizontal maxillary cut is performed above the apices of the maxillary dentition from pterygoid region of the right and left sides. The vertical cut of maxillary palate is done at midline, beneath of anterior nasal spine and near of the mesial sides of upper centrals. Later two halves of maxillary bone is separated with a fine chisel. The parasagittal osteotomy produces a three piece maxilla and accord differential movements of maxilla. The parasagittal osteotomy is employed to reposition the individual segments in a widened transverse dimension. Local anesthesia is given to the patient before performing a parasagittal osteotomy. The local anesthesia provided during the parasagittal osteotomy blocks the second trunk of the Trigeminal Nerve and hence induce the absence of sensation in the maxillary part of mouth.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a front view of a maxillary protraction device for treating Maxillary Transverse Discrepancies (MTD), according to one embodiment herein.

FIG. 2 illustrates an exploded front view of a maxillary protraction device for treating Maxillary Transverse Discrepancies (MTD), according to one embodiment herein.

FIG. 3 illustrates a top perspective view of a maxillary protraction device for treating Maxillary Transverse Discrepancies (MTD), according to one embodiment herein.

FIG. 4 illustrates an exploded perspective view of a maxillary protraction device for treating Maxillary Transverse Discrepancies (MTD), according to one embodiment herein.

FIG. 5 illustrates a perspective view of the system for treating Maxillary Transverse Discrepancies (MTD) mounted in mouth and parasagittal osteotomy sites in the maxilla.

FIG. 6 illustrates a front view of the system for treating Maxillary Transverse Discrepancies (MTD) mounted in mouth and parasagittal osteotomy sites in the maxilla, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system for treating Maxillary Transverse Discrepancies (MTD) in an adult population or in the skeletally mature people. The orthopedic and orthodontic forces are adapted to correct a maxillary transverse deficiency (MTD) in young orthodontic patients. A correction of MTD in the skeletally mature patients is more challenging because of the determination of the osseous articulations of the maxilla with the cranial bones.

According to one embodiment herein, a maxillary protraction device is provided for treating Maxillary Transverse Discrepancies (MTD) in young orthodontic patients and in skeletally mature patients using only local anesthesia and without administering general anesthesia. The maxillary protraction device comprises a hyrax and a plurality of bands is connected to the hyrax through a connecting wire. The hyrax is provided with an adjustable screw. A tongue plate is connected to the hyrax through the connecting wire. A tongue sprue wire is provided and soldered to an anterior segment of a premolar band. The tongue sprue wire is provided to reinforce the tongue plate. The connecting wire is configured to hold the tongue plate in a position to resist a functional force of a tongue. The functional force of the tongue is a pressure exerted by the tongue.

According to one embodiment herein, the connecting wire is soldered to the plurality of bands.

According to one embodiment herein, the tongue sprue wire is soldered to an anterior segment of the connecting wire to reinforce the tongue plate.

According to one embodiment herein, the tongue plate has a split at a centre line to facilitate an action of the hyrax screw. The tongue plate further comprises two halves. The two halves of the tongue plate provide a mean to transfer the physiological forces of the tongue during swallowing.

According to one embodiment herein, the tongue plate has an acrylic coverage to transfer a force of a tongue to the hyrax. The acrylic coverage further connects two halves of the tongue plate to provide more convenience to the patients.

According to one embodiment herein, the hyrax along with the tongue plate is configured to correct a growth pattern of a mandible in a horizontal direction to achieve a normal growth pattern. The movement of the hyrax increases mandibular plane angle, which in turn enables normal growth pattern of the mandible.

According to one embodiment herein, the hyrax along with the tongue plate is configured to move a maxilla anteriorly and vertically.

According to one embodiment herein, the bands are soldered and cemented to an upper position of a first molar before an osteotomy process to hold the hyrax and the mounted tongue plate to move the maxilla in a forward and vertical direction using a tongue pressure, to correct an abnormal lateral relationship of a patient to achieve a vertical control of the patient to achieve a horizontal growth pattern.

According to one embodiment herein, the hyrax screw is adjusted to produce a bilateral force which is perpendicular to a posterior arch thereby resulting in an arch expansion.

According to one embodiment herein, the hyrax provides lateral maxillary expansion and the tongue plate applies force on maxilla in forward direction.

According to one embodiment herein, the system is provided for treating Maxillary Transverse Discrepancies (MTD) in young orthodontic patients and in skeletally mature patients. The system comprises a hyrax and a tongue plate to facilitate a maxillary expansion. The hyrax comprises a plurality of bands wrapped around a first premolar and a first molar tooth of a maxilla. The plurality of bands holds the hyrax and a mounted tongue plate with a plurality of connecting wires. The plurality of bands is cemented before performing a maxillary osteotomy. The hyrax further comprises an adjustable hyrax screw which produces a bilateral force perpendicular to a posterior arch resulting in an expansion of an arch. The adjustable hyrax screw further provides expansion by increasing the movement of maxilla in transverse direction. The hyrax screw and the plurality of the connecting wires are soldered to the plurality of bands. The tongue plate further comprises a tongue sprue wire that is soldered to a posterior segment of a connecting wire of a premolar band to reinforce the tongue plate. The tongue plate has a split in a midline/center line to facilitate an insertion of the hyrax screw. The acrylic coverage of the tongue plate transfers a physiological force of the tongue to the hyrax.

According to one embodiment herein, a physiological tongue force during a swallowing is responsible for a forward, sagittal and vertical movement of the maxilla. The tongue needs enough space to have normal physiological force. The tongue plate reduces space for the tongue movement and hence the force of tongue increases during functions such as swallowing, speech, etc. The functional activity of the tongue due to reduction in space for the movement of the tongue is responsible of maxillary expansion. The sutural loosening of the maxilla releases the maxilla from Zygomatic buttress. The maxillary midline cut facilitates a 3-dimensionsal movement of the maxilla. The maxillary midline cut further facilitates separation of the maxillary halves to correct the transverse constriction.

According to one embodiment herein, parasagittal osteotomy is conducted to create a surgical cut in the parasagittal region of the maxilla. The surgical cut is performed to release the maxillary complex from the adjacent hard cranial base components. The surgical process makes the vertical and horizontal cuts in the separate two halves of the maxillary palate. The horizontal maxillary cut is performed above the apices of the maxillary dentition from pterygoid region of the right and left sides. The vertical cut of the maxillary palate is done at midline, beneath of an anterior nasal spine and near mesial sides of upper centrals. Further two halves of the maxillary bones are separated with a fine chisel. The parasagittal osteotomy produces a three piece maxilla and accord differential movements of maxilla. The parasagittal osteotomy is employed to reposition the individual segments in a widened transverse dimension. Local anesthesia is given to the patient before performing a parasagittal osteotomy. The local anesthesia provided during the parasagittal osteotomy blocks the second trunk of the Trigeminal Nerve and hence induce the absence of sensation in the maxillary part of mouth.

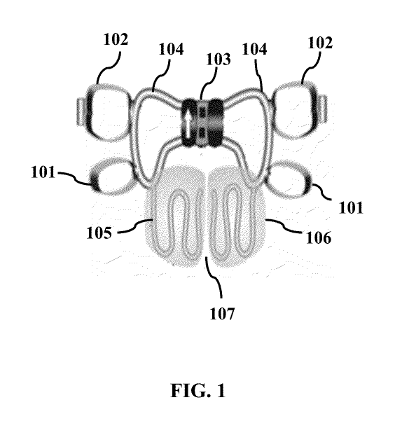

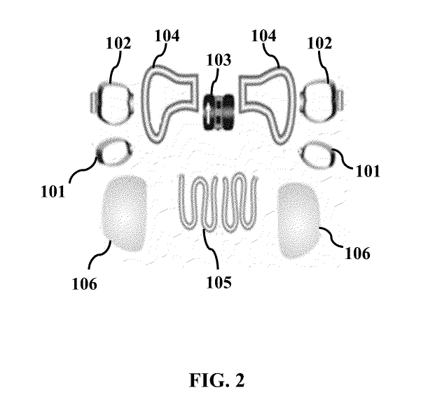

FIG. 1 illustrates a front view of a maxillary protraction device for treating Maxillary Transverse Discrepancies (MTD), according to one embodiment herein, while FIG. 2 illustrates an exploded front view of a maxillary protraction device for treating Maxillary Transverse Discrepancies (MTD), according to one embodiment herein. With respect to FIG. 1 and FIG. 2, the system comprises of hyrax and tongue plate 106 to facilitate a maxillary expansion. The hyrax comprises of plurality of bands 101 and 102 wrapped around the first premolar and the first molar teeth of the maxilla respectively. The bands 101 and 102 hold the hyrax and tongue plate 106 with connecting wires 104. The bands 101 and 102 are cemented to teeth before maxillary osteotomy is performed. The hyrax further comprises of an adjustable hyrax screw 103 which produces a bilateral force perpendicular to the posterior arch resulting in arch expansion. The hyrax screw 103 and the connecting wires 104 are soldered to the bands 101 and 102. The tongue plate 106 further comprises of tongue sprue wire 105 that is soldered to the posterior segment of the connecting wire 104 of the premolar band 101 to reinforce the tongue plate 106. The tongue plate 106 has a split in the midline 107 to facilitate the action of the hyrax screw 103. The acrylic coverage of the tongue plate 106 transfers the physiological force of the tongue to the hyrax.

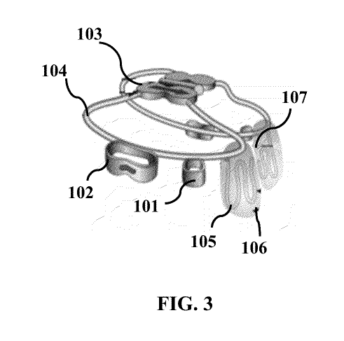

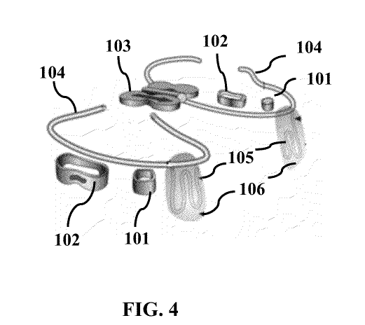

FIG. 3 illustrates a top perspective view of a maxillary protraction device for treating Maxillary Transverse Discrepancies (MTD), according to one embodiment herein, while FIG. 4 illustrates an exploded perspective view of a maxillary protraction device for treating Maxillary Transverse Discrepancies (MTD), according to one embodiment herein. With respect to FIG. 3 and FIG. 4, the system comprises of hyrax and tongue plate 106 to facilitate a maxillary expansion. The hyrax comprises of plurality of bands 101 and 102 wrapped around the first premolar and the first molar teeth of the maxilla respectively. The bands 101 and 102 hold the hyrax and tongue plate 106 with connecting wires 104. The bands 101 and 102 are cemented to teeth before maxillary osteotomy is performed. The hyrax further comprises of an adjustable hyrax screw 103 which produces a bilateral force perpendicular to the posterior arch resulting in arch expansion. The hyrax screw 103 and the connecting wires 104 are soldered to the bands 101 and 102. The tongue plate 106 further comprises of tongue sprue wire 105 that is soldered to the posterior segment of the connecting wire 104 of the premolar band 101 to reinforce the tongue plate 106. The tongue plate 106 has a split in the midline 107 to facilitate the action of the hyrax screw 103. The acrylic coverage of the tongue plate 106 transfers the physiological force of the tongue to the hyrax.

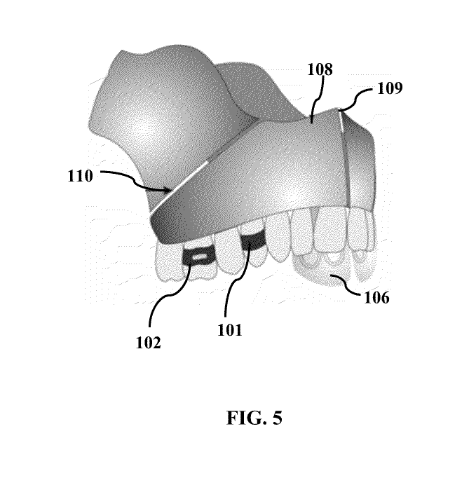

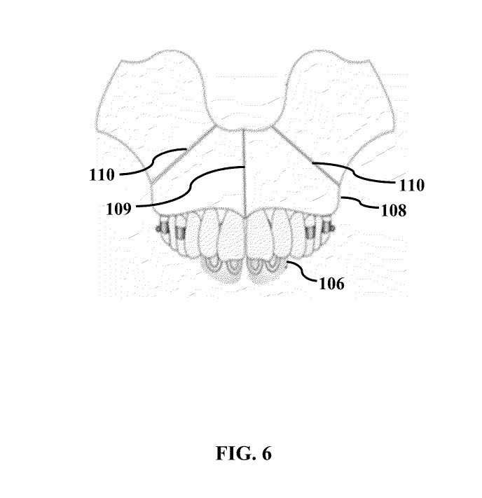

FIG. 5 illustrates a perspective view of the system for treating Maxillary Transverse Discrepancies (MTD) mounted in mouth and parasagittal osteotomy sites in the maxilla, while FIG. 6 illustrates a front view of the system for treating Maxillary Transverse Discrepancies (MTD) mounted in mouth and parasagittal osteotomy sites in the maxilla, according to one embodiment herein. With respect to the FIG. 5 and FIG. 6, the maxillary protraction device is mounted by cementing the bands 101,102 to position on top of the premolar bands. The bands 101, 1102 are soldered and cemented to an upper position of a first molar before an osteotomy process to hold the hyrax and the mounted tongue plate 106 to move the maxilla in a forward and vertical direction using a tongue pressure, to correct an abnormal lateral relationship of a patient to achieve a vertical control of the patient to achieve a horizontal growth pattern.

The sutural loosening of the maxilla releases the maxilla from Zygomatic buttress 108. Maxillary midline cut 109 facilitates 3-dimensionsal movements of the maxilla. The physiological tongue force during swallowing is responsible for the forward, sagittal and vertical movement of maxilla. The tongue force produces an effect on hyrax screw which results in creation of bilateral force in a direction perpendicular to the posterior arch resulting in arch expansion.

According to one embodiment herein, parasagittal osteotomy is conducted to create a surgical cut in the parasagittal region of the maxilla 110. The surgical cut is performed to release the maxillary complex from the adjacent hard cranial base components. The surgical process makes vertical and horizontal cuts in the separate two halves of the maxillary palate 110. The horizontal maxillary cut is performed above the apices of the maxillary dentition from pterygoid region of the right and left sides. The vertical cut of the maxillary palate 110 is done at midline, beneath of anterior nasal spine and near to mesial sides of upper centrals. Further two halves of the maxillary bones 110 are separated with a fine chisel. The parasagittal osteotomy produces a three piece maxilla and accords the differential movements of maxilla. The parasagittal osteotomy is employed to reposition the individual segments in a widened transverse dimension. Local anesthesia is given to the patient before performing parasagittal osteotomy.

The system is used for treating Maxillary Transverse Discrepancies (MTD) in both young orthodontic patients and skeletally mature patients. In older patients with reduced skeletal response, there is a high risk of dental side effects. The system overcomes the above disadvantage in adult patients since there is no need of anterior tooth anchorage. Tooth movement is one of the major problems in performing maxillary protraction. The system utilizes physiological tongue forces produced during swallowing, for the forward, sagittal and vertical movement of maxilla.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A maxillary protraction device comprising:
a hyrax;
a pluarality of bands connected to the hyrax through a connecting wire;
an adjustable screw;
a tongue plate connected to the hyrax through the connecting wire; and
a tongue sprue wire;
wherein the tongue sprue wire reinforces the tongue plate, and wherein the connecting wire holds the tongue plate in a position to resist a functional force of a tongue.

2. The device according to claim 1, wherein the connecting wire is soldered to the plurality of bands.

3. The device according to claim 1, wherein the tongue sprue wire is soldered to an anterior segment of the connecting wire to reinforce the tongue plate.

4. The device according to claim 1, wherein the tongue plate has a split at a centre line to facilitate an action of the hyrax screw.

5. The device according to claim 1, wherein the tongue plate has an acrylic coverage to transfer a force of a tongue to the hyrax.

6. The device according to claim 1, wherein the hyrax along with the tongue plate is configured to correct a growth pattern of a mandible in a horizontal direction to achieve a normal growth pattern.

7. The device according to claim 1, wherein the hyrax along with the tongue plate is configured to move a maxilla anteriorly and vertically.

8. The device according to claim 1, wherein the bands are soldered and cemented to an upper position of a first molar before an osteotomy process to hold the hyrax and the mounted tongue plate to move the maxilla in a forward and vertical direction using a tongue pressure, to correct an abnormal lateral relationship of a patient to achieve a vertical control of the patient to achieve a horizontal growth pattern.

9. The device according to claim 1, wherein the hyrax screw is adjusted to produce a bilateral force which is perpendicular to a posterior arch thereby resulting in an arch expansion.
